(19) United States
(12) Patent Application Publication
(10) Pub. No.: US 2013/0280550 A1
(43) Pub. Date: Oct. 24, 2013

(54) DEVICE HOUSING AND METHOD FOR MAKING THE SAME

(71) Applicants: CHAO-SHENG HUANG, Shenzhen City (CN); XIAO-WEI LI, Shenzhen City (CN); XIN-WU GUAN, Shenzhen City (CN); PO-FENG HO, New Taipei (TW)

(72) Inventors: CHAO-SHENG HUANG, Shenzhen City (CN); XIAO-WEI LI, Shenzhen City (CN); XIN-WU GUAN, Shenzhen City (CN); PO-FENG HO, New Taipei (TW)

(21) Appl. No.: 13/628,482

(22) Filed: Sep. 27, 2012

(30) Foreign Application Priority Data
Apr. 19, 2012 (CN) 201210116053.0

(51) Int. Cl. B05D 5/00; B05D 3/12; B29C 45/14; B32B 3/10

(52) U.S. Cl. 428/626; 428/203; 427/299; 427/290; 427/294; 427/256; 427/327

(57) ABSTRACT

A device housing includes a metallic substrate, a pattern element formed in the substrate, and a transparent or translucent decorative layer formed on the substrate and the pattern layer. The substrate defines a receiving space therein, and the pattern element is formed in the receiving space. The pattern element is made of thermosetting plastic. A method for making the device housing is also described.

### BACKGROUND

1. Technical Field

The present disclosure relates to device housing and a method for making the device housing.

2. Description of Related Art

Housings of electronic devices may be decorated by covering the surfaces of the housings with decorative sheets. The decorative sheets are commonly adhered on the surfaces by adhesive, such as glue. However, the adhered decorative sheets have a tendency to detach from the housings during use.

Therefore, there is room for improvement within the art.

### BRIEF DESCRIPTION OF THE DRAWING

Many aspects of the disclosure can be better understood with reference to the following figure. The components in the figure are not necessarily drawn to scale, the emphasis instead being placed upon clearly illustrating the principles of the disclosure. Moreover, in the drawings, like reference numerals designate corresponding parts throughout the several views.

FIG. 1 is an isometric view of an exemplary embodiment of a device housing.

FIG. 2 is a cross-sectional view of the device housing shown in FIG. 1 take along line II-II.

FIG. 3 is a schematic view of making the device housing shown in FIG. 2.

### DETAILED DESCRIPTION

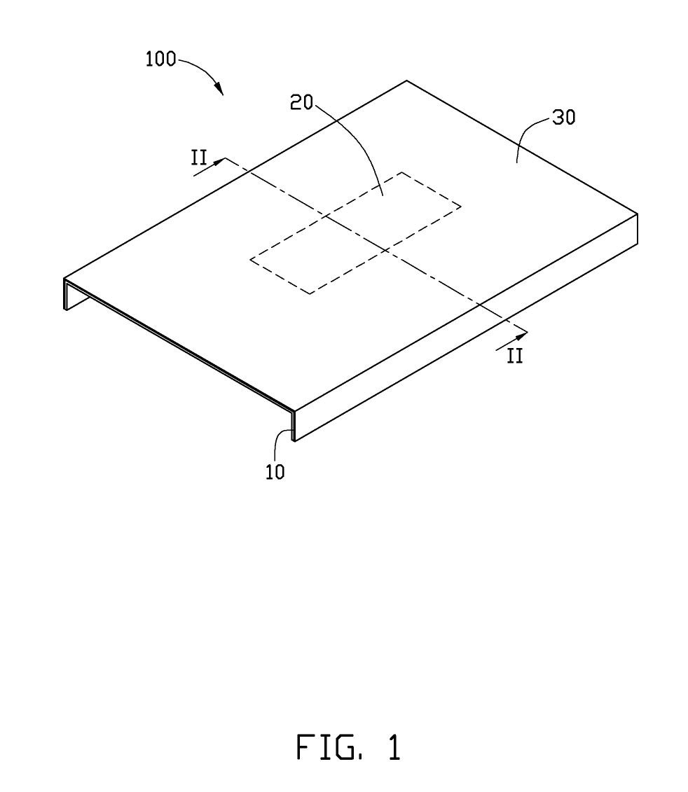

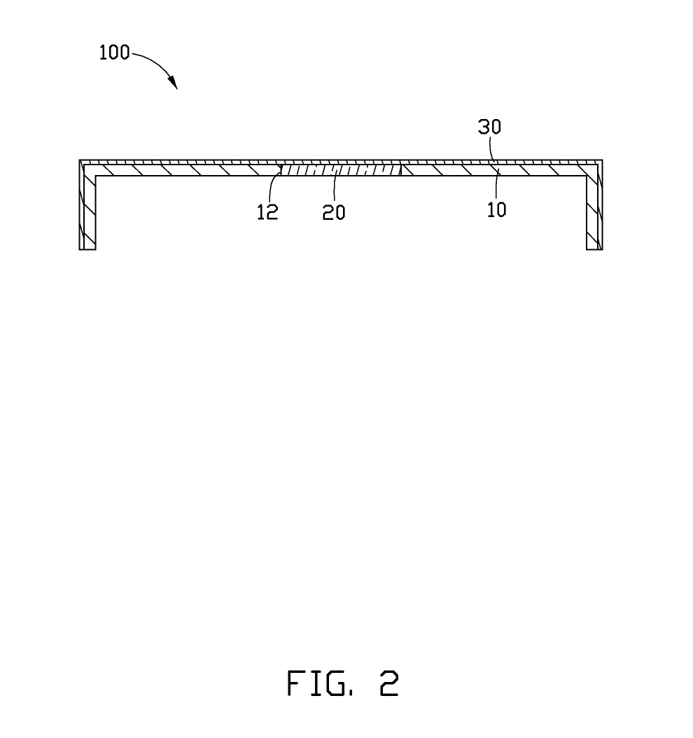

Referring to FIGS. 1 and 2, a device housing 100 according to an exemplary embodiment is shown. The device housing 100 includes a metallic substrate 10, a pattern element 20 directly formed in the metallic substrate 10, and a decorative layer 30 directly formed on the substrate 10 and the pattern element 20. As used herein, “directly” means a surface of one layer contacts a surface of the other layer.

The metallic substrate 10 may be made of stainless steel or aluminum alloy, for example. The substrate 10 defines a receiving space 12, and the pattern element 20 is formed and received in the receiving space 12.

The pattern element 20 may be designed as an identifier of characters, patterns, and/or a brand. The pattern element 20 is formed by molding thermosetting plastics in the receiving space 12 of the substrate 10; the receiving space 12 having the shape of the desired identifier of characters, patterns, and/or a brand. The thermosetting plastic may be epoxy resin, for example. Furthermore, pigments can be added to the epoxy resin to present desired colors.

The decorative layer 30 may be a transparent or translucent metallic layer formed by vacuum deposition, a transparent or translucent ink layer formed by ink printing, or a transparent or translucent paint layer formed by spray painting. The decorative layer 30 may be differently colored than the pattern element 20. As such, the regions of the pattern element 20 covered by the decorative layer 30 may present a more colorful complex pattern. The decorative layer 30 also improves the abrasion resistance and corrosion resistance of the substrate 10 and the pattern element 20.

A method for making the device housing 100 may include the following steps.

The metallic substrate 10 is provided and cleaned.

The substrate 10 is punched to form the receiving space 12.

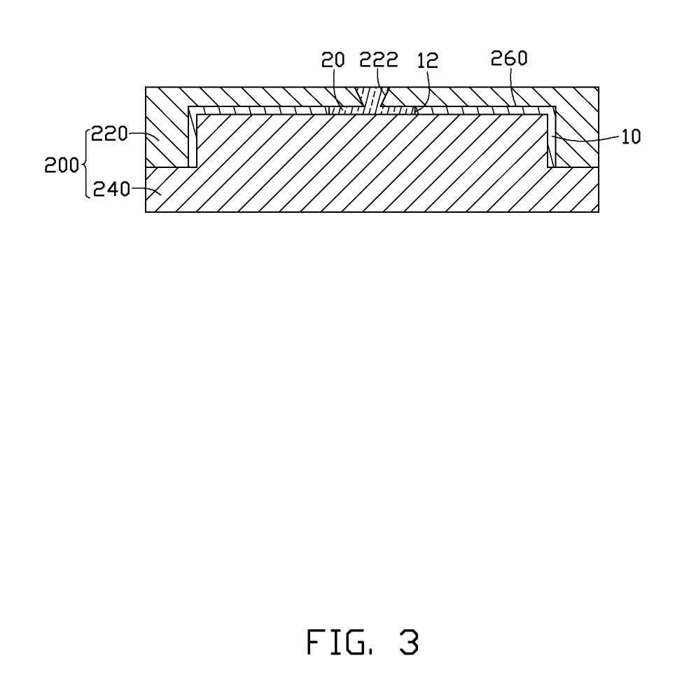

Also referring to FIG. 3, a mold 200 is provided. The mold 200 includes an upper mold 220, a lower mold 240, and a cavity 260 formed between the upper mold 220 and the lower mold 240. The upper mold 220 defines a gate 222.

The substrate 10 is located in the cavity 260, and epoxy resin is injected through the gate 222 to fill the receiving space 12 and then heated to form the pattern element 20. The solidified epoxy resin formed in the gate 222 will be cut after the pattern element 20 is formed.

The surfaces of the substrate 10 and the pattern element 20 are polished until smooth.

The decorative layer 30 is formed on the substrate 10 and the pattern element 20.

In the exemplary embodiment, the pattern element 20 of the device housing 100 is molded in the substrate 10 using thermosetting plastics, which greatly enhances the bond between the pattern element 20 and the substrate 10. Furthermore, the regions of the pattern element 20 covered by the decorative layer 30 can form a more complex and colorful pattern, which enhances decoration of the device housing 100.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. A device housing, comprising:
a metallic substrate defining a receiving space therein;
a pattern element directly formed in the receiving space, the pattern element being made of thermosetting plastic; and
a transparent or translucent decorative layer directly formed on the substrate and the pattern layer.

2. The device housing as claimed in claim 1, wherein the thermosetting plastic is epoxy resin.

3. The device housing as claimed in claim 2, wherein the epoxy resin comprises pigment.

4. The device housing as claimed in claim 1, wherein the decorative layer is a metallic layer, an ink layer, or a paint layer.

5. The device housing as claimed in claim 1, wherein the metallic substrate is made of stainless steel or aluminum alloy.

6. A method for making a device housing, comprising:
providing a metallic substrate;
forming a receiving space in the substrate;
forming a pattern element in the substrate by molding thermosetting plastic in the receiving space;
forming a transparent or translucent decorative layer on the substrate and the pattern element.

7. The method as claimed in claim 6, wherein molding thermosetting plastic in the receiving space uses a mold, the mold comprises an upper mold, a lower mold, and a cavity formed between the upper mold and the lower mold, the upper mold defines a gate, the substrate is located in the cavity, and thermosetting plastic is injected through the gate to fill the receiving space and heated to form the pattern element.

8. The method as claimed in claim 7, wherein the thermosetting plastic is epoxy resin.

9. The method as claimed in claim 6, further comprising a step of polishing the surfaces of the substrate and the pattern element after forming the pattern element.

10. The method as claimed in claim 6, wherein the receiving space is formed by punching the substrate.

11. The method as claimed in claim 6, wherein the decorative layer is formed by vacuum deposition.

12. The method as claimed in claim 6, wherein the decorative layer is formed by ink printing.

13. The method as claimed in claim 6, wherein the decorative layer is formed by spray painting.

14. The method as claimed in claim 6, wherein the metallic substrate is made of stainless steel or aluminum alloy.
